(19) United States
(12) Patent Application Publication
(10) Pub. No.: US 2009/0171642 A1
(43) Pub. Date: Jul. 2, 2009

(54) METHODS AND SYSTEMS FOR IMPROVING FREE ENERGY ESTIMATION OF FRAGMENTS

(75) Inventors: George Talbot, Philadelphia, PA (US); Matthew Clark, Wayne, PA (US)

Correspondence Address: PEPPER HAMILTON LLP, ONE MELLON CENTER, 50TH FLOOR, 500 GRANT STREET, PITTSBURGH, PA, 15219, US

(73) Assignee: LOCUS PHARMACEUTICALS, INC., Blue Bell, PA (US)

(21) Appl. No.: 11/965,139

(22) Filed: Dec. 27, 2007

(51) Int. Cl. G06G 7/48

(52) U.S. Cl. 703/12

(57) ABSTRACT

Methods and systems for estimating the free energy of molecules from a plurality of fragments are disclosed. A number of poses for each fragment in an unbound state and a sum of the free energy values for each fragment may be determined. A number of acceptable poses for each of a plurality of fragments when bound may also be determined. An entropy loss may be estimated based on at least the number of acceptable poses for each of the plurality of fragments when bound and the number of poses for each fragment in an unbound state. A free energy value may be determined for the plurality of fragments when bound based on the entropy loss.

### BACKGROUND

The present disclosure generally relates to methods and systems of improving free energy estimation of molecules built from fragments.

Determinations of protein structures have previously been conducted by isolating crystals of a protein of interest and analyzing structures using X-ray crystallography. Typically, the protein has been co-crystallized with a heavy metal component, or subjected to multiple co-crystallizations, with the heavy metal providing a reference for solving the crystallographic data.

With a determination of the structure of a protein, or the structure of another macromolecule having significant tertiary structure, such as DNA or RNA, binding sites can be identified that might be significant to a biological process, such as an enzyme active site or a site for interacting with another macromolecule or with itself. Computational efforts have focused on sampling the surface of a molecule to find good fits with known binding agents. Such methods are dependent on knowledge of the structure of good binding agents and the function of the protein.

A more traditional approach has sought to co-crystallize binding substances with the macromolecule to identify binding sites. With the binding site identified, an educated guess can be made as to new molecules that could bind to the site. Such educated guesses can guide synthetic methods, including combinatorial chemistry methods, to make and test new molecules. When such prospective binding agents are effective, the structural correlations drawn from the results can be tied to information about the binding site to make still further inferences about the structure important to a biological function. This co-crystallization approach depends on an initial knowledge of active agents and is experimentally difficult and time consuming.

Directly determining the free-binding energy of molecules during molecular computational analysis or other analytical techniques is computationally expensive. As such, attempts to avoid directly calculating the free-binding energy has resulted in search methods based on descriptors, grids and fragments.

Descriptor matching methods analyze the proposed receptor region at which binding is to take place. Ligand atoms are then positioned that the best locations at the site. The approximated ligand-receptor configuration can then be refined via optimization techniques. Descriptor matching methods are reasonably fast and provide a good sampling of the region of interest at the receptor site. Such methods employ combinational search strategies. As such, small changes in parameter values can cause the required computational time to become unreasonably long.

Grid search methods are used to sample the six degrees of freedom of the orientation space. These methods identify an approximate solution, which cannot be guaranteed, with discrete sampling methods. Accuracy is limited based on the step size used in the search of various positions. The step size also determines the search time (i.e., the search time increases proportionately with the number of incremental steps). Methods that use additional sampling in regions of high complementarity can limit the computational effort to some degree. Exemplary grid search methods include a side chain spheres method and a soft docking method.

The side chain spheres method explores protein-protein complexes using simplified sphere representations of side chain atoms and a grid search of four rigid degrees of freedom Surface evaluation algorithms, full molecular force-field evaluations of complexes and simulated annealing are used to refine initial docking structures.

The soft docking method divides receptor and ligand surfaces into cubes to generate the translational part of the search. A pure rotational grid search is conduced on the sample ligand at orientations in discrete angular increments. The accuracy of this method is limited by size. The time to perform run-time scaling is based on the cube of the rotational step size and is a product of the number of the receptor-ligand surface points.

Fragment-joining methods identify regions of high complementarity by docking functional groups independently into receptors. Such methods are not particularly affected by rigid ligand issues because of an additional combinational search. Fragment-joining methods suggest unsynthesized compounds, but connecting the fragments in sensible, synthetically accessible patterns is difficult. One problem with such methods is that the methods must connect functional groups to form complete molecules while maintaining the fragments at the geometric positions of lowest energy. Exemplary fragment-joining methods include GROW (Upjohn Laboratories of Kalamazoo, Mich.); GROWMOL; GROWBUILD; HOOK (Harvard University); MCSS-HOOK-DLD; and LUDI (BASF of Stuttgart, Germany).

GROW is a fragment-joining method that has been used to design peptides complementary to proteins of a known structure. A seed amino acid is placed in the receptor site followed by iterative additions of amino acids. Conformations are chosen from a library of predetermined low-energy forms. At each addition of a peptide, the peptide-receptor complex is minimized and evaluated. Only the best 10-100 low-energy structures are kept at any stage.

GROWMOL generates molecules by evaluating each new atom added to molecules according to the chemical complementarity of the atom to nearby atoms on the molecule. A Boltzmann weighting factor is used to bias the probability of selection towards atoms with a high complementarity score. The chemical complementarity is determined by calculating the number of hydrophobic contacts (i.e., the number of ligand carbon atoms other than carbonyl atoms that occupy a predefined “hydrophobic zone”) and the number of hydrogen bonds (i.e., the number of ligand hydrogen atoms in a predefined “hydrogen acceptor zone” plus the number of ligand oxygen atoms in a predefined “hydrogen bond donor zone”).

GROWBUILD grows molecules by the addition of fragments from a library including a functional group, such as a hydroxyl, a carbonyl or a benzene ring. At each setup, possible fragment additions are evaluated according to their molecular mechanics energy and one of the best fragments is randomly chosen. No information about critical binding regions is initially used to identify disconnected regions of the active site which must be filled.

HOOK finds hot spots in receptor sites by looking for low energy locations for functional groups. HOOK randomly places a plurality of copies of a plurality of functional fragments and applies molecular dynamics algorithms.

MCSS-HOOK-DLD methods involve the location of favorable interaction sites for molecular fragments by performing a multiple copy simultaneous search (MCSS). In such a search, a protein is subject to the average potential field of the ligands as determined using the CHARMM empirical force field. The resulting interaction sites, unlike with GRID, contain orientation information and can be linked together with bonding force fields and linker sp³ and sp₂ carbon atoms via DLD (dynamic ligand design) or molecular fragments in a database (HOOK). MCSS-based approaches require substantial computational effort (several days of preparation time on a modern workstation followed by approximately an hour of computation for each ligand candidate).

LUDI proposes inhibitors by connecting fragments that dock into microsites on the receptor. The fragments are selected from a predetermined list of molecular fragments. The microsites are defined by hydrogen bonding and hydrophobic groups. Ligand psuedoatom positions are generated within microsites on the basis of an appropriate angle and distance minima for various interactions. The identified fragments are connected using linear chains composed of one or more of a plurality of functional groups.

GRID software is a hybrid grid and fragment-joining method that places small fragment probes at many regularly spaced grid points within an active receptor site. The software has been shown to reproduce the positions of important hydrogen bonding groups. It uses empirical hydrogen bonding interaction potential and spherical representations of functional groups to generate affinity contours for various molecular fragments. This identifies regions of high and low affinity. The contours can be used to guide chemical intuition or as an input for other analysis programs. The software is limited by its representation of fragments, which does not allow for prediction of fragment orientation.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “molecular fragment” is a reference to one or more molecular fragments and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a computer-implemented method of estimating the free energy of molecules assembled from a plurality of fragments may include determining a number of poses for each fragment in an unbound state, determining a sum of the free energy values for each fragment, determining a number of acceptable poses for each of a plurality of fragments when bound, estimating an entropy loss based on at least the number of acceptable poses for each of the plurality of fragments when bound and the number of poses for each fragment in an unbound state, and determining a free energy value for the plurality of fragments when bound based on the entropy loss.

In an embodiment, a system for estimating the free energy of molecules assembled from a plurality of fragments may include a processor, and a processor readable storage medium. The processor readable storage medium may contain one or more instructions the free energy of molecules assembled from a plurality of fragments. The instructions may include determining a number of poses for each fragment in an unbound state, determining a sum of the free energy values for each fragment, determining a number of acceptable poses for each of a plurality of fragments when bound, estimating an entropy loss based on at least the number of acceptable poses for each of the plurality of fragments when bound and the number of poses for each fragment in an unbound state, and determining a free energy value for the plurality of fragments when bound based on the entropy loss.

### BRIEF DESCRIPTION OF THE DRAWINGS

Aspects, features, benefits and advantages of the present invention will be apparent with regard to the following description and accompanying drawings, of which:

FIG. 1 depicts a flow diagram for an exemplary method of estimating the free energy of molecules assembled from a plurality of fragments according to an embodiment.

FIG. 2 depicts an exemplary model for determining bond angle and bond distances between two fragments according to an embodiment.

FIG. 3 depicts a block diagram of an exemplary system that may be used to contain or implement instructions for estimating the free energy of molecules assembled from a plurality of fragments according to an embodiment.

### DETAILED DESCRIPTION

Conventional search methods typically place a plurality of fragment types on a protein and evaluate the fragment-protein interaction energies. When two fragments in low-energy poses are situated so that they may form a bond, hydrogen atoms are removed from two heavy atoms that are aligned in the correct geometry and a bond is computationally made between the two fragments. The binding energy of the assembled fragments is computed by adding the individual contributions of the fragments. However, conventional search methods do not account for entropy loss due to the reduced number of poses of two or more connected fragments as compared to the product of the number of poses for each individual fragment. This entropy loss is required for correct computation of the free energy of the binding of the connected fragments.

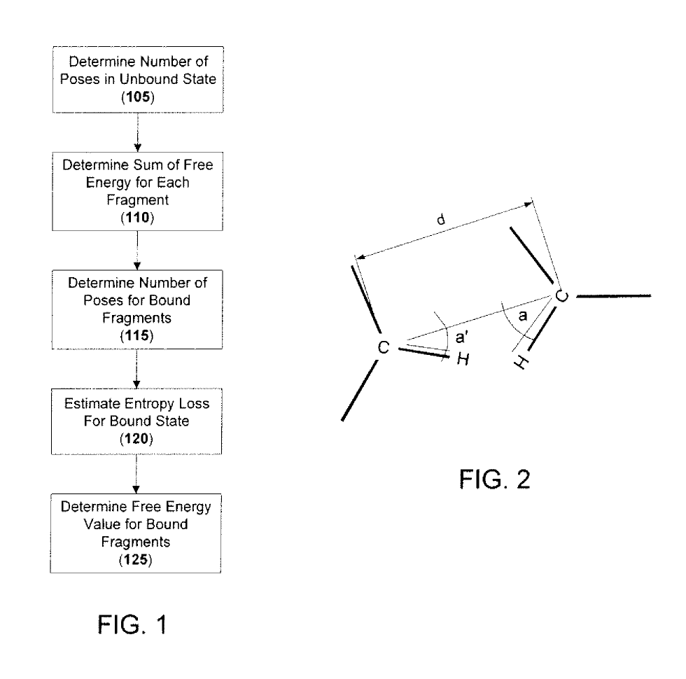

FIG. 1 depicts a flow diagram for an exemplary method of estimating the free energy of molecules assembled from a plurality of fragments according to an embodiment. A list of fragment poses interacting with a protein and the corresponding energies, E₁, may be produced using a sampling method and a molecular mechanics force field to compute the fragment-protein energy. The molecular mechanics force field may include AMBER, CHARMM, OPLS or any similar molecular mechanics force field. An energy cutoff may be selected, such that high-energy fragments with negligible Boltzmann weight,

$$exp ( \frac{- {E}_{i}}{kT} ) ,$$

where k is the Boltzmann constant and T is an absolute temperature, are discarded from the samples. Moreover, the procedure used to construct translations and rotations may provide substantially uniform coverage of the fragment configuration space. As such, configuration integrals in statistical mechanics equations may be reasonably approximated with sums over the computed poses. For example, a partition sum, Z, which corresponds to the sum of the total energy for all fragments in the entire system, may be computed using a simple sum over poses as shown in Equation (1):

$$Z = {\sum }_{i} exp ( \frac{- {E}_{i}}{kT} ) . \qquad ( 1 )$$

The Helmholtz free energy, F for the entire system may then be computed using Equation (2):

F=−kT ln(Z). (2)

As shown in FIG. 1, a number of poses for each fragment may be determined 105 with the fragment in an unbound state. For example, in a reference unbound state of 1 mol/L, all poses may have zero interaction energy (i.e., E₁=0) within a volume V₀=1660 Å³. The number of poses may be determined 105 by computing

$$\frac{{n}_{R} {V}_{0}}{{Δ}_{x} {Δ}_{y} {Δ}_{z}} ,$$

where n_{R} is the number of rotations for a fragment, and Δₓ, Δ_{y} and Δ_{z} are the translational resolutions in the x, y and z directions, respectively. This value provides a partition function for the reference state,

$${Z}_{0} = \frac{{n}_{R} {V}_{0}}{{Δ}_{x} {Δ}_{y} {Δ}_{z}} ,$$

because the Boltzmann weight for each pose is equal to 1.

The corresponding Helmholtz free energy for the system may be determined 110 by computing F₀=−kT ln(Z₀). Thus, the Helmholtz free energy of binding is ΔF=F−F₀. Because changes in pressure and volume during binding are negligible, the Gibbs free energy of binding, ΔG, is approximately equal to ΔF. The binding enthalpy may be determined according to Equation (3):

$$Δ H = \frac{1}{Z} {\sum }_{i} {E}_{i} exp ( \frac{- {E}_{i}}{kT} ) . \qquad ( 3 )$$

The binding entropy may be determined according to Equation (4):

$$Δ S = \frac{( Δ H - Δ G )}{T} . \qquad ( 4 )$$

Systematic sampling of poses may permit the application of statistical thermodynamics principles to determine free energies of independent fragments as discussed above. However, most molecules of pharmaceutical interest are complex and correspond to several fragments. Binding poses and energies of several fragments may he computed independently and used to connect those fragments having proximity that, when superposed, suggest that they could exist as connected moieties. For example, two atoms may be connected along vectors formed between a heavy atom and an attached hydrogen. Alternately, if two methyl groups are sufficiently overlapping, the methyl groups may be merged. The bond distance, d in FIG. 2, may be assigned an ideal value, such as, for example and without limitation, 1.54 Å. In an embodiment, bonds may be viably formed if, for example, the distance between two carbon atoms in separate fragments is within a specified tolerance of the ideal value. Alternately or additionally, bonds may only be formed if, for example, both angle a and angle a′ in FIG. 2 are within a selected tolerance value for hydrogen atoms on the heavy atom. If the applicable criteria are met, hydrogen atoms corresponding to the bond location may be removed from each fragment, and a bond may be created between the appropriate heavy atoms.

The systematic sampling results for a plurality of fragments may be used in automatic or user-assisted assembly of fragments into a molecule. As such, reducing the volume of data to a representative subset of the sampling results may reduce the required amount of computational processing. The representative subset may also ease graphical display of the molecule.

In order to reduce the volume of data required for consideration when assembling fragments into molecules, the poses may be reduced after sampling by selecting a subset of poses that represent the total number of poses sampled. This may permit poses that are closely oriented to be collapsed into a single pose that represents the set. However, each reduced pose may store information for the population of poses that it represents for the thermodynamic computations. This data reduction is referred to herein as “clumping.”

Clumping is based on the RMS movement of non-hydrogen atoms that are involved in bonds to other fragments. A clumping algorithm may iterate through all sampled poses and output a set of clusters referred to herein as “clumps.” Clumping is performed by selecting a pose and determining if a clump already exists within a predetermined distance of the center of mass. Other poses that have not been assigned to a clump are then compared with the selected pose. If the non-hydrogen atoms of an unassigned pose are within a specified distance from a seed pose, the unassigned pose is added to the clump for the seed pose. Otherwise, a new clump, including the unassigned pose, may be created with the selected pose as its base. The process may continue until all sampled poses are assigned to clumps.

A distance criterion may he selected from the clumping by considering each bondable atom to be the pivot point for a lever arm (assuming, for example, an idealized 1.54 Å distance to a potential bond candidate atom). By rotating the fragment around this lever arm, a maximum distance exists for which a heavy atom bonded to the pivot point may move before the potential candidate position would move to a position outside a selected angular tolerance with respect to the original position. As such, relating a desired bond angle tolerance for connecting fragments to a distance criterion for the clumping may be enabled. The distance corresponding to the desired bond angle tolerance may be approximated by

$$\frac{sin ( angle tolerance )}{2} * 1.54 Å .$$

A desired bond distance tolerance may also be specified, and the lesser of the bond distance tolerance and the distance computed from the bond angle tolerance may be used.

Each clump may be represented by a single pose selected from the group of poses within the clump, and the number of poses that was conflated to create the clump may be recorded for normalization of the free energy values. As such, the partition stun, Z_{clump}, which corresponds to the sum of the total energy for all fragments in the clump, may be determined using Equation (5):

$${Z}_{clump} = {\sum }_{i} exp ( \frac{- {E}_{i}}{kT} ) . \qquad ( 5 )$$

The free energy value for the clump may be determined using Equation (6):

E_{clump}=kT ln(Z_{clump}) (6)

The enthalpy of the clump may be computed based on the member poses using Equation (7):

$${H}_{clump} = \frac{{\sum }_{i} {E}_{i} exp ( \frac{- {E}_{i}}{kT} )}{{Z}_{clump}} . \qquad ( 7 )$$

The binding free energy values for joined fragments may be computed from the thermodynamic properties of the individual fragments. However, when one fragment is bonded to another fragment, the bond distance and angle requirements limit the number of poses that are considered. As such, the fragment energy may be re-integrated using only the poses that satisfy the bonding requirements. The entire clump may be re-integrated as the reference state Z₀. The molecular binding free energy may be approximated as the sum of these re-integrated fragment binding energies.

The thermodynamic properties of the individual fragments may be determined using Equations (1)-(4). However, for two joined fragments, a and b, the reference state Z₀ from Equation (1) does not equal the product Z₀ₐ-Z_{0b}. While the true reference state could be computed by a full simulation, including torsion flexibility, of the combined molecule, the combinatorial connection of fragments may be used to estimate the binding free energies of a plurality of molecules with significantly less computation.

The number of acceptable poses in the reference state of two joined fragments when bound may be determined 115 with respect to the individual fragments using a plurality of factors. For example, one or more poses for a fragment may be discarded based on the torsional degree of freedom about the bond joining the fragments. In addition, some poses of a joined fragment may collide with poses of the other joined fragment. Such poses would be inaccessible to the joined pair. Yet another limiting factor may include the restrictions regarding bond length and bond angles for the joined fragments.

A reference state approximation is provided by Equation (8) below, where the product of the individual reference states is reduced by a factor R that accounts for the reduction in available volume from connection of the fragments, f:

$${Z}_{0} = {\prod }_{f} ( {Z}_{0 f} ) R . \qquad ( 8 )$$

Alternately, the contributions of R may be assumed to be separable among the contributing fragments, as shown in Equation (9):

$${Z}_{0} = {\prod }_{f} {Z}_{0 f} * {R}_{f} . \qquad ( 9 )$$

Referring back to FIG. 1, an entropy loss may be estimated 120 based on at least the number of acceptable poses for each of the plurality of fragments when bound and the number of poses for each fragment in an unbound state. The number of poses available for the first fragment in the combination may be assumed to be unconstrained (i.e., the unbound Z₀ for the first fragment may be used and R₀=1). For each successively joined fragment, the corresponding value of R_{f}, representing the relative entropy loss, may be equal to the ratio of the number of poses that are permissible when the fragment is Joined to the previous fragment, A_{f}, to the number of poses that are permissible when the fragment is not joined, Z₀^{ᵢ}, where:

$${R}_{f} = \frac{{A}_{f}}{{Z}_{0 f}} . \qquad ( 10 )$$

As such, the free energy for the plurality of fragments when bound may be determined by computing Equation (11):

$${Z}_{0} = {Z}_{{0}_{0}} {\prod }_{f} {A}_{f} ; \qquad ( 11 )$$

and substituting Z₀ for Z in Equation (2) (i.e., F=−kT ln(Z₀)).

The reference state Z may be determined by examining all possible combinations of two fragments with the desired tolerance of distance and angle for bonding. However, examining all possible combinations is computationally expensive. As such, the reference state may be estimated in the sampled volume by counting the number of poses of the fragments in the sampling volume and the number of poses of the two fragments that are in a position such that they can be joined together.

For each successive fragment attached to the seed fragment, the A_{f} value may be approximated by computing the proportion of the volume around the area of interest that has been excluded. Spherical searches may be performed around the center of mass of each fragment to determine N_{f}, the number of fragments that satisfy a threshold energy cutoff. In addition, the number of all fragment poses in the ensemble, C_{f}, and the expected number of samples in the volume, X_{f}, may also be used to determine A_{f}. The expected number of samples may be determined by computing

$${X}_{f} = \frac{{n}_{R} {V}_{0}}{{Δ}_{x} {Δ}_{y} {Δ}_{z}} .$$

The creation of a single bond between two fragments represents two degrees of freedom between the fragments. The ratio of N_{f} to X_{f} represents an adjustment in six degrees of freedom. In order to account for the reduction in the number of degrees of freedom, the cube root of the adjustment may be taken. As such, the expression for A_{f} is represented in Equation (12).

$${A}_{f} = \frac{{C}_{f}}{2} \sqrt[3]{\frac{{X}_{f}}{{N}_{f}}} . \qquad ( 12 )$$

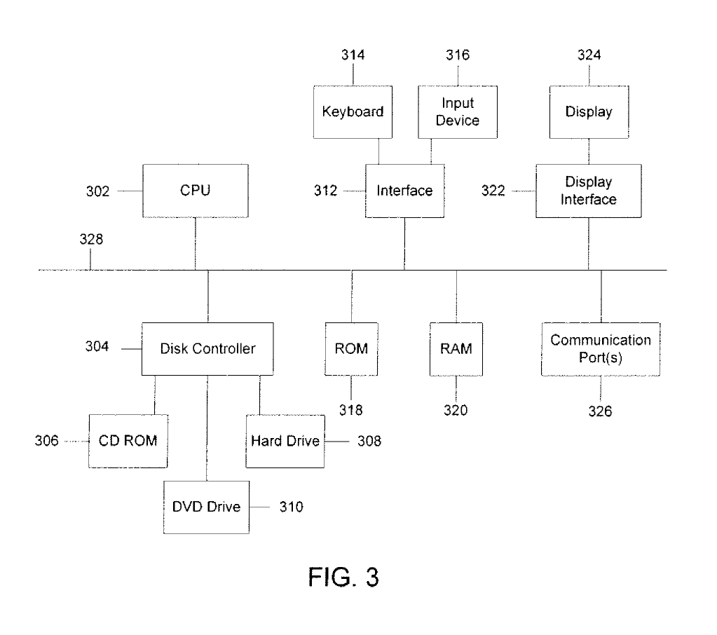

FIG. 3 depicts a block diagram of an exemplary system that may be used to contain or implement program instructions for assessing color gamut requirements for a print job and a printing device according to an embodiment. Referring to FIG. 3, a bus 328 serves as the main information highway interconnecting the other illustrated components of the hardware. CPU 302 is the central processing unit of the system, performing calculations and logic operations required to execute a program, Read only memory (ROM) 318 and random access memory (RAM) 320 constitute exemplary memory devices or storage media.

A disk controller 304 interfaces with one or more optional disk drives to the system bus 328. These disk drives may include, for example, external or internal DVD drives 310, CD ROM drives 306 or hard drives 308. As indicated previously, these various disk drives and disk controllers are optional devices.

Instructions may be stored in the ROM 318 and/or the RAM 320. Optionally, instructions may be stored on a computer readable storage medium, such as a hard drive, a compact disk, a digital disk, a memory or any other tangible recording medium.

An optional display interface 322 may permit information from the bus 328 to be displayed on the display 324 in audio, graphic or alphanumeric format. Communication with external devices may occur using various communication ports 326.

In addition to the standard computer-type components, the hardware may also include an interface 312 which allows for receipt of data from input devices such as a keyboard 314 or other input device 316 such as a mouse, remote control, pointer and/or joystick.

An embedded system may optionally be used to perform one, some or all of the operations described herein. Likewise, a multiprocessor system may optionally be used to perform one, some or all of the operations described herein.

### EXAMPLE

Sampling was performed in a cube having a volume of 27 Å³, with a translational resolution of 0.3 Å, without any protein present. Accordingly, all interaction enthalpies equal zero in this example. The approximations listed above were tested by comparing the result of the approximations to the analytic free energy, which is based only on the numbers assembled compounds.

Table 1 shows the computed free energies, with respect to a 1M reference state, of the sampled fragments. The computed free energy of 2.293 kcal/mol arises from the concentration of samples taken with respect to the 1M reference state.

TABLE 1
Free Energies of Single Fragments

| | | | | | Free |
|---|---|---|---|---|---|
| | | | | | Energy |
| | | | Sampled | | (kcal/ |
| System | Rotations | Translations | Poses, Z | Z₀ | mol) |
| Benzene | 3,520 | 1,728 | 6,082,560 | 288,048,983 | 2.293 |
| Methane | 471 | 1,728 | 813,888 | 38,542,918 | 2.293 |
| Ethane | 1,315 | 1,728 | 2,272,320 | 107,609,208 | 2.293 |

Table 2 compares the free energies determined from the analytical computation and the approximation described above. Different starting points were chosen to test the order dependence of Equation (11) and to test the behavior when different numbers of poses of each fragment were used. The Z₀ values in Table 2 were computed by multiplying the Z₀ value of the first fragment from Table 1 by the number of poses of the second fragment geometrically situated to connect to the first fragment. In each case, the analytically computed free energy and the approximated free energy are substantially similar. This suggests that the approximations used to integrate the free energy from the large number of poses in the simulation are adequate.

TABLE 2
Free Energies of Combined Fragments

| | | First | Second | | | Free | Approximated |
|---|---|---|---|---|---|---|---|
| First | Second | Fragment | Fragment | Assembled | | Energy | Free Energy |
| Fragment | Fragment | Poses | Poses | Poses, Z | Z₀ | (kcal/mol) | (kcal/mol) |
| Ethane | Benzene | 187 | 9,902 | 973,915 | 1,065,546,377,740 | 8.27 | 8.27 |
| Ethane | Benzene | 508 | 6,963 | 1,285,549 | 749,282,915,391 | 7.90 | 7.88 |
| Benzene | Ethane | 64 | 8,362 | 274,048 | 2,408,665,593,041 | 9.51 | 9.48 |
| Benzene | Ethane | 6,963 | 15,166 | 828,957 | 4,368,550,871,091 | 9.20 | 9.18 |
| Benzene | Benzene | 356 | 48 | 17,088 | 102,545,437,829 | 9.28 | 9.48 |
| Ethane | Ethane | 89 | 19,805 | 1,762,645 | 2,131,200,364,687 | 8.33 | 8.21 |

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A computer-implemented method of estimating the free energy of molecules assembled from a plurality of fragments the method comprising:
determining a number of poses for each fragment in an unbound state;
determining a sum of the free energy values for each fragment;
determining a number of acceptable poses for each of a plurality of fragments when bound;
estimating an entropy loss based on at least the number of acceptable poses for each of the plurality of fragments when bound and the number of poses for each fragment in an unbound state; and
determining a free energy value for the plurality of fragments when bound based on the entropy loss.

2. The method of claim 1 wherein determining a number of poses for each fragment comprises determining a number of poses for a fragment equal to
$$\frac{{n}_{R} {V}_{0}}{{Δ}_{x} {Δ}_{y} {Δ}_{z}} ,$$
wherein n_{R} is a number of rotations for the fragment, V₀ is a volume within which the fragment can be located, Δₓ is a translational resolution in an x-direction, Δ_{y} is a translational resolution in a y-direction, and Δ_{z} is a translational resolution in a z-direction.

3. The method of claim 1 wherein determining a free energy value for each fragment comprises determining a free energy value for a fragment by computing −kT ln(Z₀), wherein k is Boltzmann's constant, T is an absolute temperature and Z₀ is a partition function equal to
$$\frac{{n}_{R} {V}_{0}}{{Δ}_{x} {Δ}_{y} {Δ}_{z}} .$$

4. The method of claim 1 wherein determining a number of acceptable poses comprises determining a bond angle tolerance having the form
$$\frac{sin ( angle tolerance )}{2} * 1.54 Å .$$

5. The method of claim 1 wherein determining a number of acceptable poses comprises determining a bond distance tolerance.

6. The method of claim 1 wherein estimating an entropy loss comprises determining a partition sum
$${Z}_{0} = {Z}_{{0}_{0}} {\prod }_{f} {A}_{f} ,$$
wherein Z₀^{₀} is a number of poses for a first fragment in an unbound state, and A_{f} is a number of acceptable poses when a next fragment is joined to a previous fragment.

7. The method of claim 6 wherein determining a partition sum Z₀ comprises determining A_{f} to be equal to
$${A}_{f} = \frac{{C}_{f}}{2} \sqrt[3]{\frac{{X}_{f}}{{N}_{f}}} ,$$
wherein N_{f} is a number of fragments that satisfy a threshold energy cutoff; C_{f} is a number of all fragment poses in the ensemble, and X_{f} is an expected number of samples in the volume.

8. The method of claim 1 wherein one or more fragments interact with a protein structure.

9. The method of claim 8 wherein the protein-fragment interaction energy is computed using molecular mechanics force fields.

10. A system for estimating the free energy of molecules assembled from a plurality of fragments, the system comprising:
a processor; and
a processor readable storage medium containing one or more instructions for estimating the free energy of molecules assembled from a plurality of fragments, including instructions for:
determining a number of poses for each fragment in an unbound state,
determining a sum of the free energy values for each fragment,
determining a number of acceptable poses for each of a plurality of fragments when bound,
estimating an entropy loss based on at least the number of acceptable poses for each of the plurality of fragments when bound and the number of poses for each fragment in an unbound state, and
determining a free energy value for the plurality of fragments when bound based on the entropy loss.

11. The system of claim 10 wherein the one or more instructions for determining a number of poses for each fragment comprise one or more instructions for determining a number of poses for a fragment equal to
$$\frac{{n}_{R} {V}_{0}}{{Δ}_{x} {Δ}_{y} {Δ}_{z}} ,$$
wherein n_{R} is a number of rotations for the fragment, V₀ is a volume within which the fragment can be located, Δₓ is a translational resolution in an x-direction, Δ_{y} is a translational resolution in a y-direction, and Δ_{z} is a translational resolution in a z-direction.

12. The system of claim 10 wherein the one or more instructions for determining a sum of the free energy values for each fragment comprise one or more instructions for determining a free energy value for a fragment by computing −kT ln(Z₀), wherein k is Boltzmann's constant, T is an absolute temperature and Z₀ is a partition function equal to
$$\frac{{n}_{R} {V}_{0}}{{Δ}_{x} {Δ}_{y} {Δ}_{z}} .$$

13. The system of claim 10 wherein the one or more instructions for determining a number of acceptable poses comprise one or more instructions for determining a bond angle tolerance having the form
$$\frac{sin ( angle tolerance )}{2} * 1.54 Å .$$

14. The system of claim 10 wherein the one or more instructions for determining a number of acceptable poses comprise one or more instructions for determining a bond distance tolerance.

15. The system of claim 10 wherein the one or more instructions for determining a number of acceptable poses comprise one or more instructions for determining an acceptable number of poses when bound, Δ_{f}, to be equal to
$${A}_{f} = \frac{{C}_{f}}{2} \sqrt[3]{\frac{{X}_{f}}{{N}_{f}}} ,$$
wherein N_{f} is a number of fragments that satisfy a threshold energy cutoff, C_{f} is a number of fragment poses in an ensemble, and X_{f} is an expected number of samples in the volume.

16. The system of claim 10 wherein the one or more instructions for determining a free energy value for the plurality of fragments when bound based on the entropy loss comprises one or more instructions for determining the product
$${Z}_{0} = {Z}_{{0}_{0}} {\prod }_{f} {A}_{f} , \qquad$$
wherein Z₀^{₀} is a number of poses for a first fragment in an unbound state, and A_{f} is the number of acceptable poses when a next fragment is joined to a previous fragment.
